(19) United States
(12) Patent Application Publication
(10) Pub. No.: US 2026/0296058 A1
(43) Pub. Date: Oct. 1, 2026

(54) PRETREATMENT APPARATUS AND IMAGE FORMING APPARATUS

(71) Applicant: Atsushi HADA, Kanagawa (JP)

(72) Inventor: Atsushi HADA, Kanagawa (JP)

(21) Appl. No.: 19/547,742

(22) Filed: Feb. 24, 2026

(30) Foreign Application Priority Data
Mar. 25, 2025 (JP) 2025-049962

(51) Int. Cl. B41J 11/00; B05C 1/08; B05C 21/00

(52) U.S. Cl. CPC B41J 11/0015; B05C 1/0813; B05C 21/00

(57) ABSTRACT

A pretreatment apparatus includes: a pressure roller to apply pressure to a medium; a pretreatment head to discharge a pretreatment liquid toward the pressure roller; and a heater, on the pressure roller, to heat the pretreatment liquid discharged onto the heater.

### CROSS-REFERENCE TO RELATED APPLICATIONS

This patent application is based on and claims priority pursuant to 35 U.S.C. § 119(a) to Japanese Patent Application No. 2025-049962, filed on Mar. 25, 2025, in the Japan Patent Office, the entire disclosure of which is hereby incorporated by reference herein.

### BACKGROUND

### Technical Field

The present embodiment relates to a pretreatment apparatus and an image forming apparatus.

### Related Art

An inkjet type image forming apparatus suppresses smearing of ink and improves image quality by landing a pretreatment liquid for aggregating a coloring material of the ink before forming an image by landing ink droplets.

By applying the pretreatment liquid to an absorbent and transferring the pretreatment liquid from the absorbent to a sheet, uneven application of the pretreatment liquid to the sheet is suppressed.

### SUMMARY

The present disclosure provides a pretreatment apparatus including: a pressure roller to apply pressure to a medium; a pretreatment head to discharge a pretreatment liquid toward the pressure roller; and a heater, on the pressure roller, to heat the pretreatment liquid discharged onto the heater.

The present disclosure further provides a pretreatment apparatus including: a pretreatment head to discharge a pretreatment liquid onto a medium; a pressure roller to: apply pressure to the medium onto which the pretreatment liquid has been discharged by the pretreatment head; and convey the medium in a conveyance direction; and a heater, on the pressure roller, to heat the pretreatment liquid on the medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an example of an overall configuration of an image forming apparatus;

FIG. 2 is a view illustrating an example of a configuration of a liquid discharger of an image forming unit of the image forming apparatus;

FIG. 3 is a view illustrating an example of a hardware configuration of the image forming apparatus;

FIG. 4 is a view illustrating an example of a configuration of a main part of a pretreatment unit of the image forming apparatus;

FIG. 5 is a view illustrating an example of a configuration of a head array of the pretreatment unit of the image forming apparatus;

FIGS. 6A and 6B are views for explaining a coverage with a pretreatment liquid in the pretreatment unit of the image forming apparatus;

FIGS. 7A and 7B are views for explaining a gap of a head array in the pretreatment unit of the image forming apparatus;

FIG. 8 is a view illustrating an example of a configuration of a main part of a pretreatment unit of an image forming apparatus according to a first modification; and

FIG. 9 is a view illustrating an example of a configuration of a main part of a pretreatment unit of an image forming apparatus according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment of a pretreatment apparatus and an image forming apparatus will be described in detail with reference to the drawings. In addition, the present disclosure is not limited to the following embodiment, and components in the following embodiment include those that can be easily conceived by those skilled in the art, those that are substantially the same, and those within a so-called equivalent range. Furthermore, various omissions, substitutions, changes, and combinations of the components can be made without departing from the gist of the following embodiment.

### Overall Configuration of Image Forming Apparatus

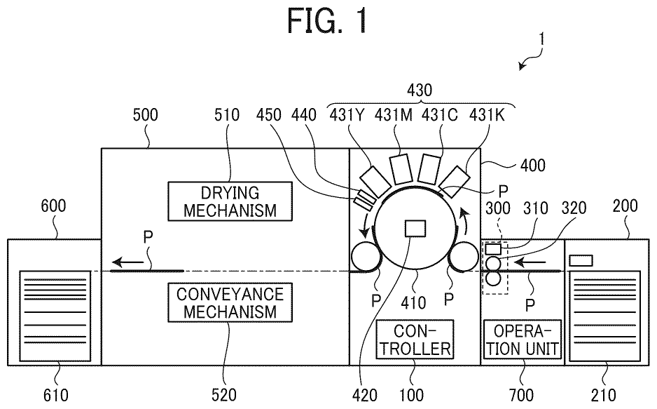

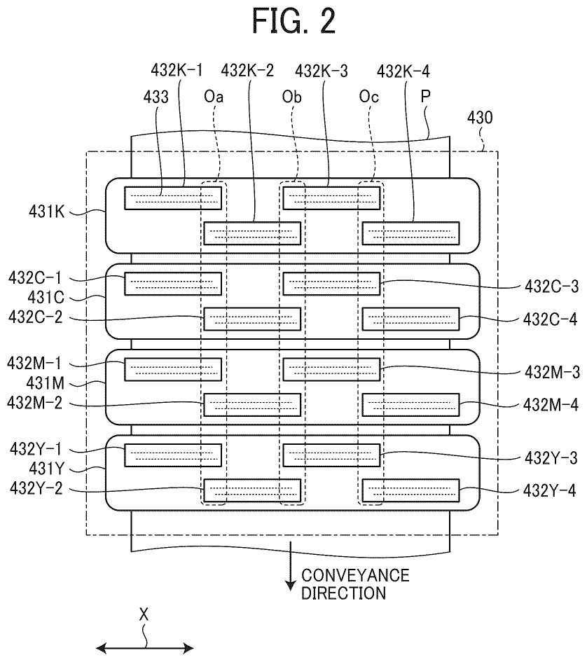

FIG. 1 is a view illustrating an example of an overall configuration of an image forming apparatus. FIG. 2 is a view illustrating an example of a configuration of a liquid discharger of an image forming unit of the image forming apparatus.

An overall configuration of an image forming apparatus 1 will be described with reference to FIGS. 1 and 2.

The image forming apparatus 1 illustrated in FIG. 1 is a commercial printer that forms an image on a sheet (recording medium) by an inkjet method. As illustrated in FIG. 1, the image forming apparatus 1 includes a controller 100, a sheet feeding unit 200, a pretreatment unit 300, an image forming unit 400, a drying unit 500, a sheet discharge unit 600, and an operation unit 700.

The controller 100 is a controller that controls entire operation of the image forming apparatus 1. Note that the controller 100 is illustrated as being included in the image forming unit 400 in the example illustrated in FIG. 1, but may be included in another unit in the image forming apparatus 1.

The sheet feeding unit 200 is a unit that separately conveys sheets P one by one from a sheet feeding tray 210 on which multiple sheets P are stacked. The separately conveyed sheets P are fed to the sheet feeding unit 200.

The pretreatment unit 300 is a unit for applying a pretreatment liquid as pretreatment to the sheet P which is a recording medium conveyed and fed from the sheet feeding unit 200. As illustrated in FIG. 1, the pretreatment unit 300 includes a head array 310 (pretreatment head) and a pressure roller 320.

The head array 310 is a device that discharges the pretreatment liquid toward the pressure roller 320. The pressure roller 320 is a pair of rollers that transfers the pretreatment liquid discharged and landed by the head array 310 to the sheet P passing between the rollers.

The sheet P to which the pretreatment liquid has been transferred by the pretreatment unit 300 is conveyed to the image forming unit 400.

The image forming unit 400 is a unit that forms an image by discharging ink onto the sheet P onto which the pretreatment liquid conveyed from the pretreatment unit 300 has been transferred. As illustrated in FIG. 1, the image forming unit 400 includes a sheet carrying drum 410, a suction device 420, a liquid discharger 430 (inkjet head), a sensor 440, and a scanner 450. The sheet carrying drum 410 is an example of a conveyor to convey the sheet P.

The sheet carrying drum 410 is a drum that conveys the sheet P conveyed from the pretreatment unit 300 along an outer circumferential surface by rotation operation in a state where the sheet P is gripped by the gripper. The suction device 420 is a device that generates suction airflow toward the inside of the sheet carrying drum 410 from multiple suction holes provided on a surface of the sheet carrying drum 410. By the suction operation by the suction device 420, the sheet P is sucked to the outer circumferential surface of the sheet carrying drum 410.

The liquid discharger 430 is a unit for discharging ink onto the sheet P conveyed by the sheet carrying drum 410 to form an image. As illustrated in FIG. 1, the liquid discharger 430 includes a head array 431K that discharges K (black) ink, a head array 431C that discharges C (cyan) ink, a head array 431M that discharges M (magenta) ink, and a head array 431Y that discharges Y (yellow) ink, which are arranged in parallel.

As illustrated in FIG. 2, the liquid discharger 430 is a line-type inkjet head, and includes head arrays 431K, 431C, 431M, and 431Y corresponding to K, C, M, and Y from an upstream side in a conveyance direction of the sheet P. In the head array 431K, four recording heads 432K-1 to 432K-4 in which multiple nozzles 433 are formed are arranged in a staggered manner. Similarly, in the head array 431C, four recording heads 432C-1 to 432C-4 in which multiple nozzles 433 are formed are arranged in a staggered manner. Similarly, in the head array 431M, four recording heads 432M-1 to 432M-4 in which multiple nozzles 433 are formed are arranged in a staggered manner. Similarly, in the head array 431Y, four recording heads 432Y-1 to 432Y-4 in which multiple nozzles 433 are formed are arranged in a staggered manner. Here, in FIG. 2, portions where end portions of nozzle rows of the nozzles 433 overlap between the adjacent recording heads when viewed from the conveyance direction are indicated by dotted line portions Oa, Ob, and Oc. Each of the multiple nozzles 433 are formed on a nozzle face of the recording heads 432M-1 to 432M-4.

The sensor 440 is a sensor that is disposed on a downstream side of the liquid discharger 430 in a rotation direction of the sheet carrying drum 410 and detects the sheet P rotationally conveyed by the sheet carrying drum 410. The scanner 450 is a reading device that performs reading operation on the sheet P on which an image is formed and which is rotationally conveyed by the sheet carrying drum 410.

The sheet P on which the image is formed by the image forming unit 400 is conveyed to the drying unit 500.

The drying unit 500 is a unit that dries the sheet P on which the image is formed, conveyed from the image forming unit 400. In the example of the image forming apparatus 1 illustrated in FIG. 1, one drying unit 500 is provided, but the number of the drying units 500 is not limited to one, and multiple drying units may be provided according to drying conditions. As illustrated in FIG. 1, the drying unit 500 includes a drying mechanism 510 and a conveyance mechanism 520.

The drying mechanism 510 is a mechanism that dries ink landed on the sheet P in the drying unit 500. The conveyance mechanism 520 is a mechanism that conveys the sheet P conveyed from the image forming unit 400.

The sheet P dried by the drying unit 500 is conveyed to the sheet discharge unit 600.

The sheet discharge unit 600 is a unit that discharges the sheet P conveyed from the drying unit 500 to a sheet discharge tray 610.

The operation unit 700 is a device that includes a touch panel, a keyboard, or the like, and receives an operation input by a user who operates the image forming apparatus 1. Note that, in the example illustrated in FIG. 1, the operation unit 700 is illustrated as being provided in the pretreatment unit 300, but may be provided in another unit in the image forming apparatus 1.

### Hardware Configuration of Image Forming Apparatus

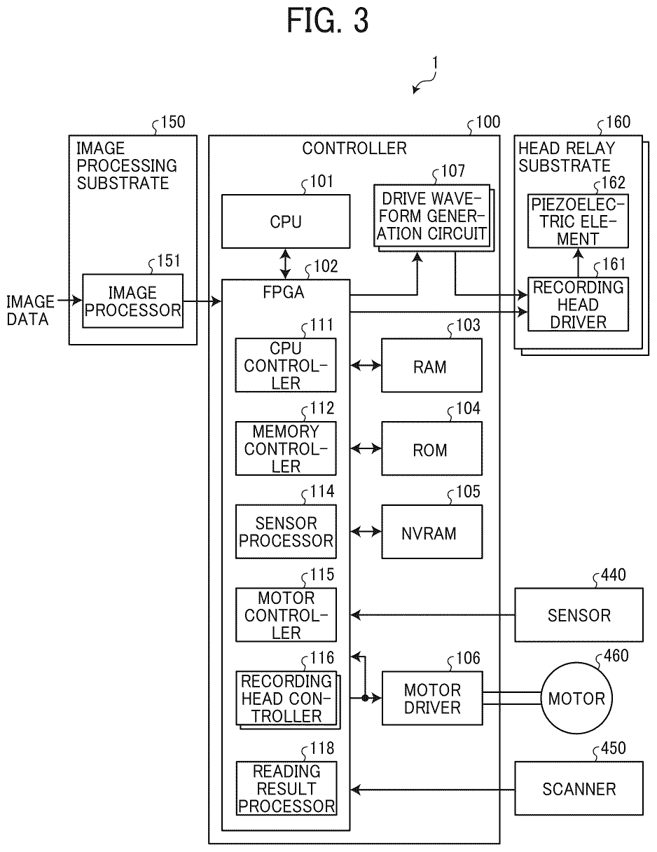

FIG. 3 is a view illustrating an example of a hardware configuration of the image forming apparatus. The hardware configuration of the image forming apparatus 1 will be described with reference to FIG. 3.

As illustrated in FIG. 3, the image forming apparatus 1 includes the controller 100, an image processing substrate 150, a head relay substrate 160, a sensor 440, a scanner 450, and a motor 460.

The controller 100 includes a central processing unit (CPU) 101, a field programmable gate array (FPGA) 102, a random access memory (RAM) 103, and a read only memory (ROM) 104, a non-volatile RAM (NVRAM) 105, a motor driver 106, and a drive waveform generation circuit 107.

The CPU 101 is an arithmetic device that controls the entire image forming apparatus 1. The CPU 101 performs various kinds of operation control while communicating with the FPGA 102.

The FPGA 102 is an arithmetic device that assists the function of the CPU 101. The FPGA 102 includes a CPU controller 111, a memory controller 112, a sensor processor 114, a motor controller 115, a recording head controller 116, and a reading result processor 118.

The CPU controller 111 controls the operation of the CPU 101. The memory controller 112 controls reading and writing of data from and to the RAM 103, the ROM 104, and the NVRAM 105.

The sensor processor 114 processes sensor information detected by the sensor 440. The motor controller 115 controls rotation operation of various kinds of motors 460 via the motor driver 106.

The recording head controller 116 controls operation of the head relay substrate 160 via the drive waveform generation circuit 107. The reading result processor 118 performs image processing on the image data read by the scanner 450. The reading result processor 118 analyzes, for example, streaks or unevenness of the read image.

The RAM 103 is a non-volatile storage device that stores a program such as an initial program loader (IPL). The RAM 104 is a volatile storage device to be used as a work area of the CPU 101.

The NVRAM 105 is a non-volatile storage device that stores various kinds of data such as programs and holds various kinds of data even while the power supply of the image forming apparatus 1 is cut off.

The motor driver 106 is a drive circuit that rotationally drives various kinds of motors 460 under the control of the motor controller 115.

The drive waveform generation circuit 107 is a circuit that generates a drive waveform for a recording head driver 161 of the head relay substrate 160 described later according to the control by the recording head controller 116.

The image processing substrate 150 is a base for performing image processing. As illustrated in FIG. 3, the image processing substrate 150 includes an image processor 151.

The image processor 151 performs predetermined image processing on image data input from the outside of the image forming apparatus 1.

The head relay substrate 160 is a substrate that controls operation of the liquid discharger 430 according to the drive waveform generated by the drive waveform generation circuit 107. As illustrated in FIG. 3, the head relay substrate 160 includes the recording head driver 161 and a piezoelectric element 162.

The recording head driver 161 is a drive circuit that operates the piezoelectric elements 162 of the head arrays 431C, 431M, 431Y, and 431K using the drive waveform generated by the drive waveform generation circuit 107 to discharge ink onto the sheet P.

The motor 460 is various kinds of motors disposed in the image forming apparatus 1.

### Configuration and Operation of Main Part of Pretreatment Unit

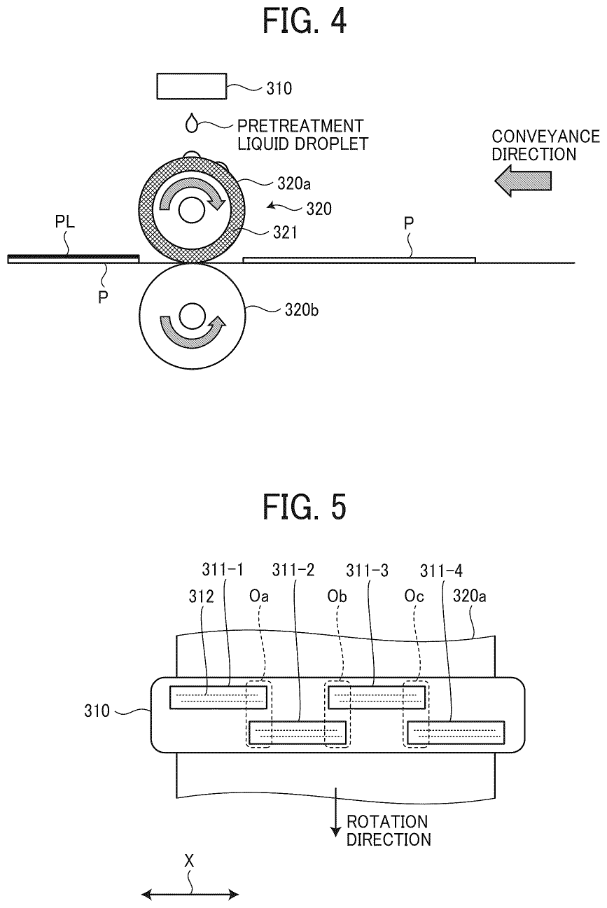

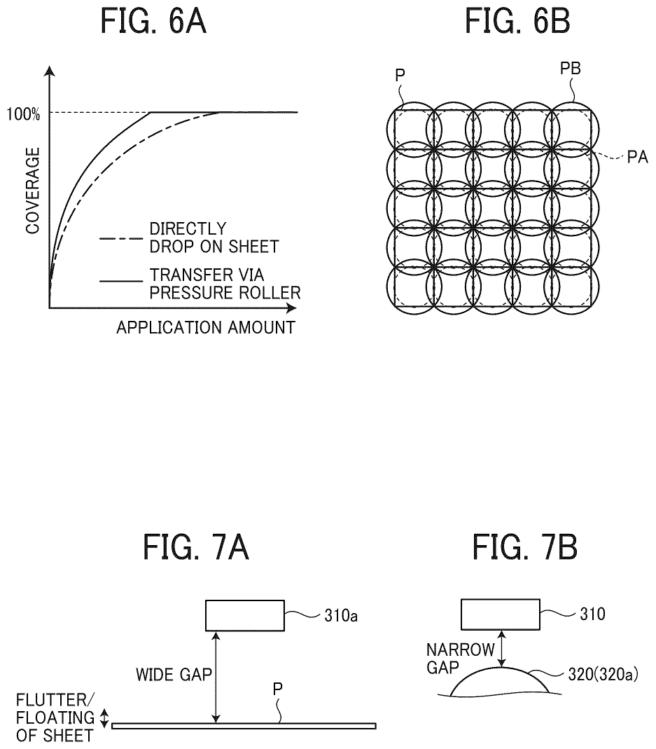

FIG. 4 is a view illustrating an example of a configuration of a main part of the pretreatment unit of the image forming apparatus. FIG. 5 is a view illustrating an example of a configuration of a head array of the pretreatment unit of the image forming apparatus. FIGS. 6A and 6B are views for explaining a coverage with the pretreatment liquid in the pretreatment unit of the image forming apparatus. FIGS. 7A and 7B are views for explaining a gap of the head array in the pretreatment unit of the image forming apparatus. With reference to FIGS. 4 to 7B, the configuration and operation of the main part of the pretreatment unit 300 will be described.

As illustrated in FIG. 4, the pressure roller 320 includes a pair of rollers including a pressure roller 320 a (first roller) disposed on an upper side and a pressure roller 320b (second roller) disposed on a lower side, and a nip portion is formed between the pressure roller 320a and the pressure roller 320b. The pressure roller 320 includes a heating mechanism 321 (heater) disposed along an outer circumferential surface of a roller surface of the pressure roller 320a. As illustrated in FIG. 4, in a case where the sheet P is conveyed from right to left, the pressure roller 320a rotates rightward, and the pressure roller 320b rotates leftward.

The head array 310 is disposed above the pressure roller 320a, discharges the pretreatment liquid downward toward the pressure roller 320a, and lands the pretreatment liquid on the roller surface of the pressure roller 320a. Here, FIG. 5 illustrates an example of a configuration of the head array 310. In the head array 310, four recording heads 311-1 to 311-4, in which multiple nozzles 312 are formed, are arranged in a staggered manner. Here, in FIG. 5, portions where end portions of nozzle rows of the nozzles 312 overlap each other between the adjacent recording heads when viewed from the rotation direction of the pressure roller 320a are indicated by dotted line portions Oa, Ob, and Oc. By providing such overlapping portions, it is possible to suppress occurrence of a portion where the pretreatment liquid is not applied on the pressure roller 320a.

Note that the head array 310 includes four recording heads 311-1 to 311-4 as illustrated in FIG. 5, but the number of recording heads is not limited to four.

The pretreatment liquid landed on the pressure roller 320a moves by the rotation of the pressure roller 320a, and when the sheet P passes through the nip portion between the pressure roller 320a and the pressure roller 320b, the sheet P is pressurized, and the pretreatment liquid on the pressure roller 320a is transferred to the sheet P. As a result, a uniformly applied pretreatment liquid surface (pretreatment layer PL) is formed on the sheet P without increasing an amount of the pretreatment liquid applied from the head array 310. In addition, the pretreatment liquid wet-spread on the pressure roller 320a is transferred onto the sheet P surface and is pressurized by the nip portion between the pressure roller 320a and the pressure roller 320b, and thus, an area covered with the pretreatment liquid can be increased as compared with the case where the pretreatment liquid is applied to the sheet P directly from the head array 310.

The pretreatment liquid landed on the pressure roller 320a is heated by the heating mechanism 321, there by excess moisture is evaporated. As a result, the pretreatment liquid is transferred to the sheet P in a state where moisture is evaporated, so that it is not necessary to separately provide a step for drying the pretreatment liquid after the step of transferring the pretreatment liquid by the pressure roller 320, and thus, it is possible to suppress cockling, or the like, generated in the step.

By transferring the pretreatment liquid to the sheet P with such a configuration of the pretreatment unit 300, as illustrated in FIG. 6A, a coverage of 100[%] can be achieved with a smaller application amount and a uniformly applied surface can be formed as compared with the case where the pretreatment liquid is directly printed (dropped) on the sheet from the head array. Specifically, as illustrated in FIG. 6B, even with the same amount of the pretreatment liquid, an area of a covered portion PB in a case where the pretreatment liquid is transferred from the pressure roller 320 in the pretreatment unit 300 is larger than an area of a covered portion PA in a case where the pretreatment liquid is directly printed (dropped) on the sheet from the head array, and a high coverage can be achieved.

In addition, as illustrated in FIG. 7A, in a case where the pretreatment liquid is directly printed on the sheet P from the head array 310a, it is preferable to secure a wide gap between the head array 310a and the sheet P in order to protect the head array 310a from flutter, floating, and the like, generated at the time of conveying the sheet P. On the other hand, in the pretreatment unit 300, the pretreatment liquid is discharged from the head array 310 to the pressure roller 320 (pressure roller 320a), and thus, the gap between the head array 310 and the pressure roller 320a can be narrowed as illustrated in FIG. 7B. This makes it possible to suppress landing variation due to discharge bending, or the like, and to easily form a uniformly applied surface.

As described above, in the pretreatment unit 300 of the image forming apparatus 1, the head array 310 discharges the pretreatment liquid, the pressure roller 320 pressurizes the sheet P to pressure-bond the pretreatment liquid to the sheet P, and the heating mechanism 321 is provided on the pressure roller 320 to heat the sheet P. As a result, it is not necessary to separately provide a step for drying the pretreatment liquid while suppressing uneven application of the pretreatment liquid, so that the step related to the pretreatment liquid can be reduced.

Specifically, the pressure roller 320 includes the pressure roller 320a, and the pressure roller 320b that is disposed below the pressure roller 320a and forms a nip portion with the pressure roller 320a, and the sheet P is pressurized by the pressure roller 320 when passing through the nip portion. The head array 310 is disposed above the pressure roller 320, discharges the pretreatment liquid downward toward the pressure roller 320, and the pretreatment liquid landed on the pressure roller 320 is transferred to the sheet P when the sheet P passes through the nip portion. As a result, the area covered with the pretreatment liquid can be increased as compared with the case where the pretreatment liquid is applied to the sheet P directly from the head array 310.

### First Modification

The image forming apparatus 1 according to a first modification will be described focusing on differences from the above-described image forming apparatus 1. Note that an overall configuration and hardware configuration of the image forming apparatus 1 are similar to those described in the above-described embodiment.

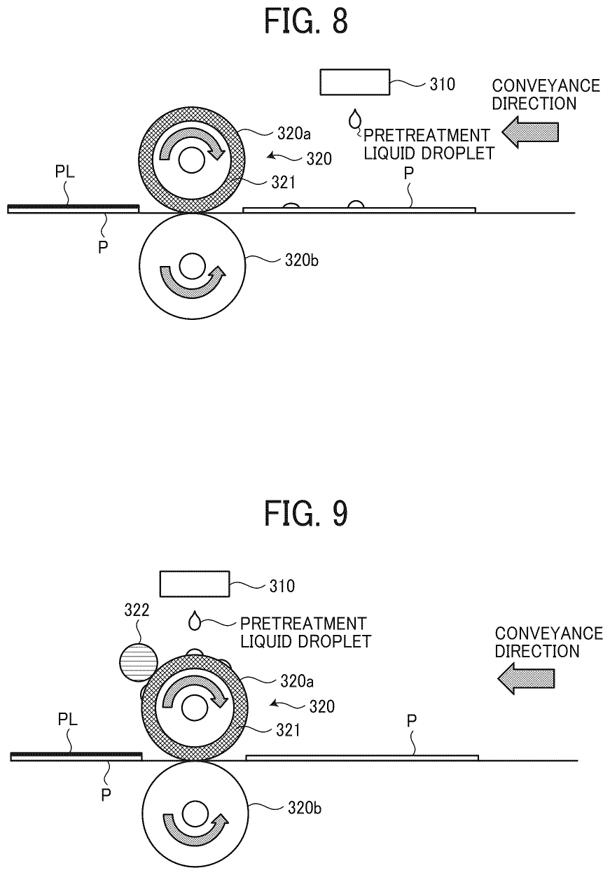

FIG. 8 is a view illustrating an example of a configuration of a main part of a pretreatment unit of the image forming apparatus according to the first modification. The configuration and operation of the main part of the pretreatment unit 300 will be described with reference to FIG. 8.

As illustrated in FIG. 8, in the pretreatment unit 300 according to the present modification, the head array 310 is disposed on the upstream side of the position where the pressure roller 320 is arranged in the conveyance direction of the sheet P. Then, the head array 310 discharges the pretreatment liquid downward toward the sheet P to land the pretreatment liquid on the sheet P. Then, when the sheet P passes through the nip portion between the pressure roller 320a and the pressure roller 320b, the pretreatment liquid that has landed on the sheet P is pressure-bonded by the nip portion, and excess moisture is evaporated by heating of the sheet P by the heating mechanism 321.

As a result, the area covered with the pretreatment liquid can be increased, and a uniformly applied pretreatment liquid surface (pretreatment layer PL) is formed on the sheet P. Further, the moisture is evaporated by the heating mechanism 321 together with the pressure bonding of the pretreatment liquid at the nip portion, so that it is not necessary to separately provide a step for drying the pretreatment liquid after the step for the pretreatment liquid by the pressure roller 320, and thus, it is possible to suppress cockling, or the like, generated in the step.

### Second Modification

The image forming apparatus 1 according to a second modification will be described focusing on differences from the above-described image forming apparatus 1. Note that an overall configuration and hardware configuration of the image forming apparatus 1 according to the second modification are similar to those described in the above-described embodiment.

FIG. 9 is a view illustrating an example of a configuration of a main part of a pretreatment unit of the image forming apparatus according to the second modification. The configuration and operation of the main part of the pretreatment unit 300 will be described with reference to FIG. 9.

As illustrated in FIG. 9, the pretreatment unit 300 according to the present modification includes a cleaning mechanism 322 (remover) as illustrated in FIG. 9 in addition to the components of the pretreatment unit 300 illustrated in FIG. 8 described above. The cleaning mechanism 322 is a mechanism that removes excess pretreatment liquid remaining on the roller surface of the pressure roller 320a at a position on the roller surface on the upstream side from the position on the pressure roller 320a on which the pretreatment liquid discharged from the head array 310 lands. The pretreatment liquid application method in the image forming apparatus 1 according to the present modification is implemented by the pretreatment unit 300 configured as a separate unit independent from the image forming unit 400 that forms an image, and thus, it is easy to implement a configuration for removing the transfer residue of the pretreatment liquid by the cleaning mechanism 322.

With the configuration of the pretreatment unit 300 according to the present modification as described above, the pretreatment liquid is newly landed on the pressure roller 320a from the head array 310 after the excess pretreatment liquid on the pressure roller 320a is removed, so that uniformity of the pretreatment liquid to be transferred to the sheet P can be further improved.

Note that the cleaning mechanism 322 of the pretreatment unit 300 according to the present modification can also be applied to the pretreatment unit 300 according to the first modification described above.

In the embodiment and the modifications described above, in a case where at least one of the functional units of the image forming apparatus 1 is implemented by execution of a program, the program is provided by being incorporated in advance in a ROM, or the like. Furthermore, in the embodiment and the modifications described above, the program to be executed by the image forming apparatus 1 may be provided by being recorded in a computer-readable recording medium such as a compact disc read only memory (CD-ROM), a flexible disk (FD), a compact disk-recordable (CD-R), or a digital versatile disc (DVD) as a file in an installable format or an executable format. Furthermore, in the embodiment and the modifications described above, the program to be executed by the image forming apparatus 1 may be stored on a computer connected to a network such as the Internet and provided by being downloaded via the network. Furthermore, in the embodiment and the modifications described above, the program to be executed by the image forming apparatus 1 may be provided or distributed via a network such as the Internet. Furthermore, in the embodiment and the modifications described above, the program to be executed by the image forming apparatus 1 has a module configuration including at least one of the above-described functional units, and as actual hardware, the CPU 101 reads and executes the program from the above-described storage device (such as, for example, the ROM 104 and the NVRAM 105), so that the above-described functional units are loaded and generated on the main storage device (RAM 103).

A pretreatment apparatus includes: a pressure roller to apply pressure to a medium; a pretreatment head to discharge a pretreatment liquid toward the pressure roller; and a heater, on the pressure roller, to heat the pretreatment liquid discharged onto the heater.

The pressure roller includes: a first roller including the heater to heat the pretreatment liquid discharged onto the heater by the pretreatment head; and a second roller disposed below the first roller, the first roller and the second roller form a nip between the first roller and the second roller, and the first roller transfers the pretreatment liquid heated by the heater onto the medium passing through the nip.

The pretreatment head is disposed above the first roller to discharges the pretreatment liquid downward toward the first roller, and the first roller, together with the second roller, applies pressure and heat to the medium passing through the nip.

The first roller includes the heater on an outer circumferential surface of the first roller.

The pretreatment apparatus further includes: a remover disposed upstream of a landing position of the pretreatment liquid discharged from the pretreatment head onto the first roller in a rotation direction of the first roller, and the remover to contact an outer surface of the heater on the first roller to remove the pretreatment liquid remaining on the outer surface of the heater on the first roller.

The pressure roller convey the medium in a conveyance direction, the pretreatment head includes multiple heads arranged in a staggered manner in a transverse direction orthogonal to the conveyance direction, and the multiple heads have an overlapped portion between each ends of two adjacent heads of the multiple heads in the transverse direction.

An image forming apparatus includes: the pretreatment apparatus to apply the pretreatment liquid from a first nozzle face of the pretreatment head onto the medium; an inkjet head to discharge an ink from a second nozzle face of the inkjet head onto the medium onto which the pretreatment liquid is applied by the pretreatment apparatus; and a conveyor to convey the medium from the pretreatment apparatus to the inkjet head.

The pretreatment head has a first gap between the first nozzle face of the pretreatment head and an outer surface of the heater on the pressure roller; and the inkjet head has a second gap, larger than the first gap, between the second nozzle face of the inkjet head and a surface of the medium conveyed by the conveyor.

A pretreatment apparatus includes: a pretreatment head to discharge a pretreatment liquid onto a medium; a pressure roller to: apply pressure to the medium onto which the pretreatment liquid has been discharged by the pretreatment head; and convey the medium in a conveyance direction; and a heater, on the pressure roller, to heat the pretreatment liquid on the medium.

The pretreatment head is disposed upstream of the pressure roller in the conveyance direction, and the pretreatment head discharges the pretreatment liquid toward the medium.

According to the embodiment, it is possible to reduce steps relating to the pretreatment liquid while suppressing uneven application of the pretreatment liquid.

Aspects of the present embodiment are as follows.

### First Aspect

According to a first aspect, a pretreatment apparatus mounted on an image forming apparatus includes
a pretreatment head that discharges a pretreatment liquid,
a pressure roller that pressure-bonds the pretreatment liquid to a recording medium by pressurizing the recording medium, and
a heater that is provided in the pressure roller and heats the recording medium.

### Second Aspect

According to a second aspect, in the pretreatment apparatus of the first aspect,
the pressure roller includes
a first roller, and
a second roller disposed below the first roller and forming a nip portion between the second roller and the first roller, and
the recording medium is pressurized by the pressure roller when the recording medium passes through the nip portion.

### Third Aspect

According to a third aspect, in the pretreatment apparatus of the second aspect,
the pretreatment head is
disposed above the first roller, and
discharges the pretreatment liquid downward toward the first roller, and
the pretreatment liquid landed on the first roller is transferred to the recording medium when the recording medium passes through the nip portion.

### Fourth Aspect

According to a fourth aspect, in the pretreatment apparatus of the first or the second aspect,
the pretreatment head is
disposed on an upstream side of a position where the pressure roller is disposed in a conveyance direction of the recording medium, and
discharges the pretreatment liquid toward the recording medium.

### Fifth Aspect

According to a fifth aspect, in the pretreatment apparatus of the second or the third aspect, the heater is disposed along an outer circumferential surface of a roller surface of the first roller.

### Sixth Aspect

According to a sixth aspect, the pretreatment apparatus of the second or the third aspect further includes a remover that removes the pretreatment liquid remaining on a roller surface of the first roller at a position on the roller surface on an upstream side from a position on the first roller where the pretreatment liquid discharged from the pretreatment head is landed.

### Seventh Aspect

According to a seventh aspect, in the pretreatment apparatus of the second or the third aspect,
the pretreatment head includes multiple recording heads,
the multiple recording heads is arranged in a staggered manner, and
end portions of nozzle rows formed in the recording heads overlap each other between adjacent recording heads among the multiple recording heads when viewed from a rotation direction of the first roller.

### Eighth Aspect

According to an eighth aspect, an image forming apparatus includes
the pretreatment apparatus of any one of the first to the seventh aspects, and
an inkjet head that discharges ink onto the recording medium onto which the pretreatment liquid is applied by the pretreatment apparatus to form an image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A pretreatment apparatus comprising:
a pressure roller to apply pressure to a medium;
a pretreatment head to discharge a pretreatment liquid toward the pressure roller; and
a heater, on the pressure roller, to heat the pretreatment liquid discharged onto the heater.

2. The pretreatment apparatus according to claim 1,
wherein the pressure roller includes:
a first roller including the heater to heat the pretreatment liquid discharged onto the heater by the pretreatment head; and
a second roller disposed below the first roller,
the first roller and the second roller form a nip between the first roller and the second roller, and
the first roller transfers the pretreatment liquid heated by the heater onto the medium passing through the nip.

3. The pretreatment apparatus according to claim 2,
wherein the pretreatment head is disposed above the first roller to discharges the pretreatment liquid downward toward the first roller, and
the first roller, together with the second roller, applies pressure and heat to the medium passing through the nip.

4. The pretreatment apparatus according to claim 2,
wherein the first roller includes the heater on an outer circumferential surface of the first roller.

5. The pretreatment apparatus according to claim 2, further comprising:
a remover disposed upstream of a landing position of the pretreatment liquid discharged from the pretreatment head onto the first roller in a rotation direction of the first roller, and
the remover to contact an outer surface of the heater on the first roller to remove the pretreatment liquid remaining on the outer surface of the heater on the first roller.

6. The pretreatment apparatus according to claim 2,
wherein the pressure roller convey the medium in a conveyance direction,
the pretreatment head includes multiple heads arranged in a staggered manner in a transverse direction orthogonal to the conveyance direction, and
the multiple heads have an overlapped portion between each ends of two adjacent heads of the multiple heads in the transverse direction.

7. An image forming apparatus comprising:
the pretreatment apparatus according to claim 1 to apply the pretreatment liquid from a first nozzle face of the pretreatment head onto the medium;
an inkjet head to discharge an ink from a second nozzle face of the inkjet head onto the medium onto which the pretreatment liquid is applied by the pretreatment apparatus; and
a conveyor to convey the medium from the pretreatment apparatus to the inkjet head.

8. The image forming apparatus according to claim 7,
wherein the pretreatment head has a first gap between the first nozzle face of the pretreatment head and an outer surface of the heater on the pressure roller; and
the inkjet head has a second gap, larger than the first gap, between the second nozzle face of the inkjet head and a surface of the medium conveyed by the conveyor.

9. A pretreatment apparatus comprising:
a pretreatment head to discharge a pretreatment liquid onto a medium;
a pressure roller to:
apply pressure to the medium onto which the pretreatment liquid has been discharged by the pretreatment head; and
convey the medium in a conveyance direction; and
a heater, on the pressure roller, to heat the pretreatment liquid on the medium.

10. The pretreatment apparatus according to claim 9,
wherein the pretreatment head is disposed upstream of the pressure roller in the conveyance direction, and
the pretreatment head discharges the pretreatment liquid toward the medium.
